(19) United States
(12) Patent Application Publication
(10) Pub. No.: US 2009/0051675 A1
(43) Pub. Date: Feb. 26, 2009

(54) HIGH TRANSMISSION RATE INTERFACE FOR TRANSMITTING BOTH CLOCKS AND DATA

(75) Inventor: Chun-Yi Huang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/964,011

(22) Filed: Dec. 25, 2007

(30) Foreign Application Priority Data
Aug. 20, 2007 (TW) 96130678

(51) Int. Cl. G06F 3/038

(52) U.S. Cl. 345/204

(57) ABSTRACT

A high transmission rate interface for transmitting both a clock and data, which is adapted for an intra-panel liquid crystal display (LCD), is disclosed. The high transmission rate interface includes: a clock detection circuit adapted for receiving a data stream and detecting a specific data format in the data stream so as to extract clock information from the data stream; and a data extraction circuit coupled to the clock detection circuit and adapted for sampling the data stream according to the clock information and extracting an image data according to a sampling result.

### CROSS-REFERENCE TO RELATED APPLICATION

This application claims the priority benefit of Taiwan application serial no. 96130678, filed on Aug. 20, 2007. The entirety of the above-mentioned patent application is hereby incorporated by reference herein and made a part of this specification.

### BACKGROUND OF THE INVENTION

1. Field of the Invention

The present invention generally relates to a high transmission rate interface, and more particularly, to an intra-panel high transmission rate interface for transmitting both clocks and data.

2. Description of Related Art

Recently, display panel technologies become more mature, in that in response to the demands of consumers, sizes of the display panels are required to become larger and larger, and resolutions thereof are required to be higher and higher. However, a display panel having a larger size and a higher resolution definitely requires a higher intra-panel operation frequency.

A conventional intra-panel interface requires a plurality of transmission line pairs. When the transmission lines are operated in a high frequency, it is hard for the transmission lines to obtain similar electrical characteristics. Therefore, it is also difficult for a receiving terminal to provide a calibration system, and thus the bit error rate can not be sufficiently decreased. Moreover, additional costs are required for solving this problem. This defect impairs the competitiveness of the products.

As is well known, red color, blue color, and green color are three primary colors of visible lights. Therefore, image data can be composed of red image data, green image data, and blue image data. Referring to FIG. 1. FIG. 1 is a diagram of a transmission interface in a conventional LCD panel. As shown in FIG. 1, image data R/G/B Data are transmitted into intra-panel driving chips via a clock signal transmission line 10, and a plurality of image data transmission line pairs 11 and 12. In FIG. 1, the first image data transmission line pair is labelled as 11, and the others are all labelled as 12. Each of the transmission line pairs is coupled to input terminals of all of the driving chips. As shown in FIG. 1, an N-bit image data R/G/B Data can be composed of an N-bit red image data R1, R2, . . . RN, green image data G1, G2, . . . GN, and blue image data B1, B2, . . . BN. The principle of operation thereof is that each of image data transmission line pairs 11 and 12 uses rising edges and falling edges of a clock signal CLK to extract image data R/G/B Data, and transmit the same to input terminals of all intra-panel driving chips. Taking the first image data transmission line pair 11 as an example, when the clock signal CLK changes from a low level to a high level, the first image data transmission line pair 11 extracts a first bit R1 of the red image data. When the clock signal CLK changes from the high level to a low level, the first transmission line pair intercepts a second bit R2 of the red image data. Principles of operation of the rest image data transmission line pairs 12 are similar to that of the image data transmission line pair 11, and thus omitted herein for brevity. In this manner, assuming that a pixel has 10 bits of image data, if the same structure of the interface shown in FIG. 1 is utilized, it can be seen that 15 image data transmission pairs and a clock signal transmission line are required.

The foregoing example is called as a reduce swing differential signalling (RSDS) transmission interface. The above-mentioned RSDS transmission interface transmits signals via transmission line pairs, and the signal swing is allowed to be small. Therefore, the RSDS transmission interface introduces fewer electromagnetic interferences (EMI), and can support high-frequency applications. Unfortunately, each of the transmission line pairs must be connected to the input terminals of all of the driving chips, so the load is excessively high. Further, each of the transmission line pairs is operated in a different environment. The operational difference between the transmission line pairs may introduce some problems when the RSDS interface is used in a high-frequency environment.

Referring to FIG. 2, FIG. 2 is a diagram of another transmission interface in a conventional display panel. As shown in FIG. 2, image data R/G/B Data are transmitted into intra-panel driving chips via a clock signal transmission line 20, and an image data transmission line pair 21. For a single driving chip, only one transmission line 20 and a transmission pair 21 are coupled to an input terminal of the single driving chip. The principle of operation thereof is that the image data transmission line pair 21 uses rising edges and falling edges of the clock signal CLK to extract image data R/G/B Data and transmit the image data R/G/B Data to a driving chip connected thereto. Referring to FIG. 2, suppose that there are N bits of image data, when the clock signal CLK changes from a low level to a high level, the image data transmission line pair 21 extracts a first bit R1 of the red image data. Then when the clock signal CLK changes from the high level to a low level, the image data transmission line pair 21 extracts a second bit R2 of the red image data. In this way, the image data transmission line pair 21 sequentially extracts the red image data R1 through RN, the green image data G1 through GN, and the blue image data B1 through BN.

The foregoing example is called as a point-to-point differential signalling (PPDS) transmission interface. This interface is characterized by its point-to-point transmission. Therefore, the load of the transmission terminal of such an interface is relatively low and easily evaluated. In addition, this kind of interface requires less transmission line pairs in accordance with a single driving chip. However, such a structure still requires an extra control signal to perform some control so as to ensure relativity between line pairs, so as to avoid extracting incorrect data. Further, the PPDS interface employs an independent clock signal when it operates in a high-frequency environment. This may introduce the problems of EMI and clock skew.

Referring to FIG. 3, FIG. 3 is a diagram of another transmission interface of a conventional display panel. In FIG. 3, image data R/G/B Data and a clock signal CLK are transmitted to a driving chip in the panel via only a single pair of transmission line 30. In other words, each driving chip corresponds to only one single transmission line pair 30 for inputting data. The principle of operation thereof is to define the image data R/G/B Data and the clock signal CLK by using different amplitudes, so that the clock signal CLK can be extracted by detecting amplitudes of the input signal. After the clock signal CLK is intercepted, the clock signal CLK is then transmitted to a delayed locked loop (DLL) to generate clock signals having different phases. Then these clock signals having different phases are used to extract the image data RIG/B Data. As shown in FIG. 3, the transmission line pair 30 includes a clock signal CLK, a control signal C, a dummy signal D, and N bits of image data R/G/B Data. The N bits of image data R/G/B Data can be composed of N bits of red image data R1 through RN, green image data G1 through GN, and blue image data B1 through BN. Amplitude of the clock signal CLK has an absolute value greater than absolute values of amplitudes of the image data R/G/B Data, the dummy signal D, and the control signal C. Further, by determining how many bits of image data R/G/B Data are included in a single pixel, it can be learnt that how many clock signals CLK having different phases are required for completing the transmission. Taking a 10-bit image data R/G/B Data for example, completing a transmission of a pixel requires 33 clock signals CLK of different phases including 30 clock signals corresponding to the image data R/G/B Data, one clock signal CLK corresponding to the control signal C, one clock signal CLK corresponding to the clock signal itself, and a clock signal CLK corresponding to the dummy signal D.

The foregoing example is proposed in a paper titled “An Advanced Intra-Panel Interface with Clock Embedded Multi-Level Point-to-Point Differential Signaling for Large-Sized TFT LCD Applications” published in SID by Samsung Inc. in 2006. Such a transmission interface also adopts a point-to-point transmission mode, so that the load at the transmission terminal is lower and is easy to be estimated and controlled. In addition, this interface does not need to consider an environmental consistency between different transmission line pairs, but requires two additional comparators to detect the amplitude. Furthermore, the interface compares with a voltage of a single point, so that when a signal overshooting/undershooting phenomenon occurs, the interface is poor in noise immunity. Therefore, incorrect determination of the clock signals is likely to happen. In other words, the phases of the determined clocks may be incorrect. Therefore, if the incorrect clocks are utilized to extract the image data, incorrect image data are extracted accordingly. Moreover, the image data has only two voltage levels. If the resolution is too high, errors may occur when this interface is used in a high-frequency environment.

Therefore, the present invention provides a high transmission rate interface transferring both the clock and the data signals to overcome the aforementioned problems.

### SUMMARY OF THE INVENTION

Accordingly, the present invention is directed to a high transmission rate interface, and more particularly, to a high transmission rate interface which has advantages of low load, low power consumption, low noise interference, and no clock skew. The interface is preferably adapted for an intra-panel transmission.

The present invention provides a high transmission rate interface for transmitting both a clock and data, adapted for an intra-panel liquid crystal display (LCD). The high transmission rate interface comprises a clock detection circuit and a data extraction circuit. The clock detection circuit is adapted for receiving a data stream and detecting a specific data format in the data stream so as to extract clock information from the data stream. The data extraction circuit is coupled to the clock detection circuit and is adapted for sampling the data stream according to the clock information and extracting an image data according to a sampling result.

According to an embodiment of the high transmission rate interface of the present invention, the data stream is carried by a multi-level voltage signal, the multi-level voltage signal comprises a plurality of voltage levels, and each of the voltage levels represents an m-bit binary code.

The present invention provides a high transmission rate interface for transmitting both a clock and data, adapted for a liquid crystal display (LCD). The high transmission rate interface comprises an encoder and a clock detection circuit. The encoder is used for embedding clock information with a specific data format into a data stream. The clock detection circuit is adapted for receiving the data stream and detecting the specific data format, so as to extract the clock information from the data stream.

According to an embodiment of the high transmission rate interface of the present invention, the encoder further encodes image data, so as to form the data stream.

In one embodiment, the aforesaid high transmission rate interface further comprises a data extraction circuit. The data extraction circuit is coupled to the clock detection circuit and is adapted for sampling the data stream according to the clock information and extracting the image data according to a sampling result.

In one embodiment, the aforesaid high transmission rate interface further comprises a comparison circuit is adapted for receiving the multi-level voltage signal and is used for comparing the multi-level voltage signal with a reference signal to generate the data stream.

In one embodiment, the aforesaid data extraction circuit comprises a delayed locked loop, a sampling unit and a decoding unit. The delayed locked loop is coupled to the clock detection circuit for generating a plurality of clock signals having different phases according to the clock information. The sampling unit is coupled to the comparison unit and the delayed locked loop and is used for sampling the data current according to the clock signals having different phases to derive the sampling result. The decoding unit is coupled to the sampling unit and is used for receiving the sampling result and decoding the sampling result to obtain the image data.

### BRIEF DESCRIPTION OF THE DRAWINGS

The accompanying drawings are included to provide a further understanding of the present invention, and are incorporated to constitute a part of this specification. The drawings illustrate embodiments of the invention and, together with the description, serve to explain the principles of the present invention.

FIG. 1 is a diagram of a transmission interface in a conventional LCD panel.

FIG. 2 is a diagram of another transmission interface in a conventional display panel.

FIG. 3 is a diagram of another transmission interface of a conventional display panel.

FIG. 4 is a diagram showing a 3-bit binary code encoding table according to the first embodiment of the present invention.

FIG. 5 is a diagram showing a waveform diagram of a transmission signal according to the first embodiment of the present invention.

FIG. 6 depicts the first embodiment applied in a display panel environment.

FIG. 7 is a functional block diagram of a data receiving apparatus according to the first embodiment of the present invention.

FIG. 8 shows circuits of a comparison unit 701 and a clock signal detector 702 of the data receiving apparatus shown in FIG. 7.

FIG. 9 shows circuits of a comparison unit 701 and a clock signal detector 702 of another data receiving apparatus shown in FIG. 7.

FIG. 10 is another waveform diagram of a transmission signal according to the first embodiment of the present invention.

FIG. 11 is a flowchart illustrating a method comprising an encoding step and an extracting step according to the first embodiment of the present invention.

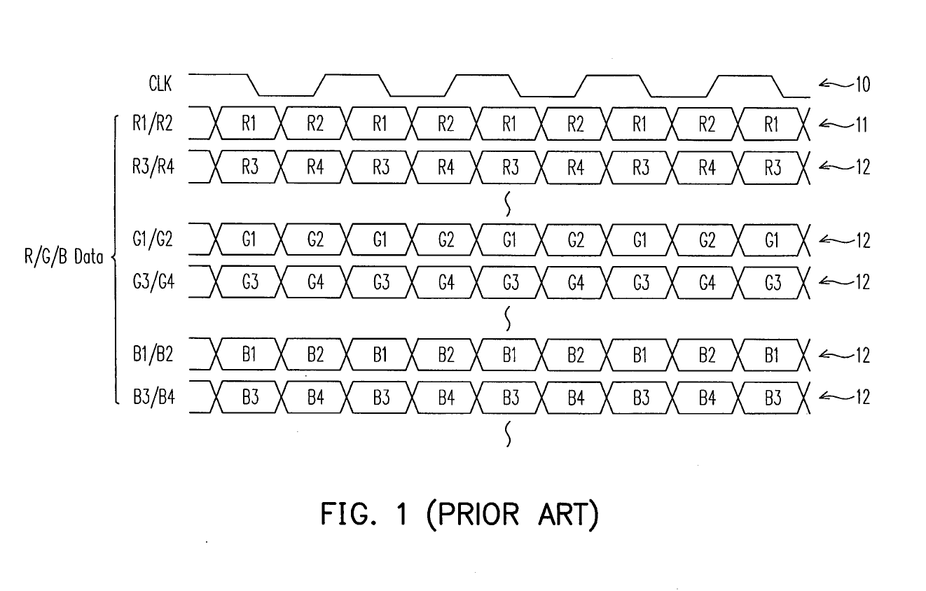

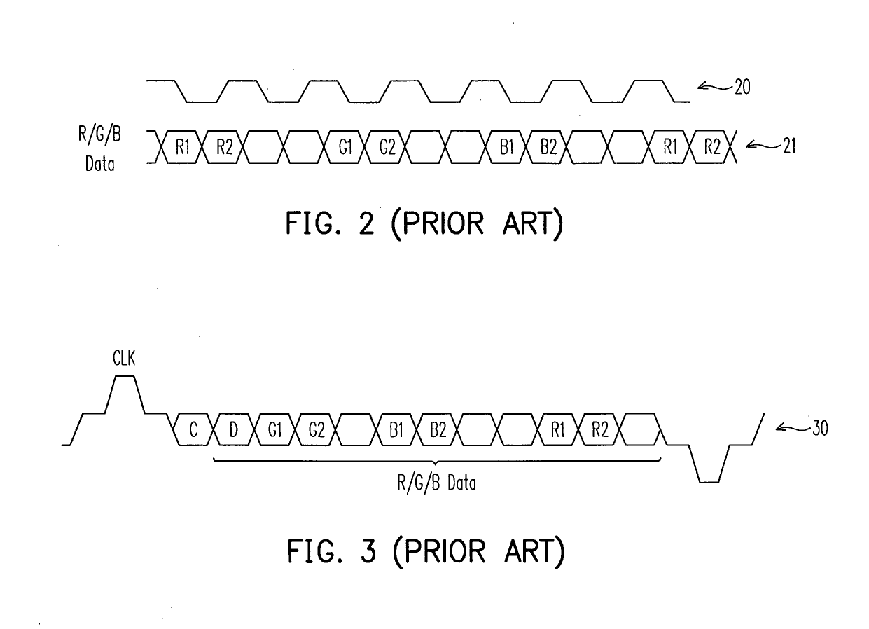

### DESCRIPTION OF THE EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

As mentioned above, either a single line pair or multiple line pairs are utilized for transmission, the conventional transmission interface often uses two voltage levels to represent logic levels 1 and 0. However, as the operation frequency is getting higher, the entire system becomes difficult to design. A multi-level design requiring a lower operation frequency is believed to be an effective solution. Unfortunately, conventional multi-level designs including clock signals require a very long period of time for synchronization. Furthermore, since there are often many driving chips in the display panel, all the driving chips have to be adjusted to have similar characteristics so as to achieve a synchronously output of the image data of the entire image. This makes the multi-level structure more difficult to design. As such, the conventional multi-level design is not suitable for large-sized display panels.

The present invention provides a high transmission rate interface having a multi-level signal for transferring a clock signal and a data signal, and a method thereof. The principle is to employ a specific encoding strategy to divide a conventional multi-bit binary code into two first codes having a lower bit number. According to this specific encoding strategy, there would be additional codes, which can be utilized as clock information of a clock signal. Then a simple circuit can be used to intercept and extract the clock signal. Because the structure of the present invention is very simple, driving chips of the same display panel exhibit similar characteristics without special arrangement.

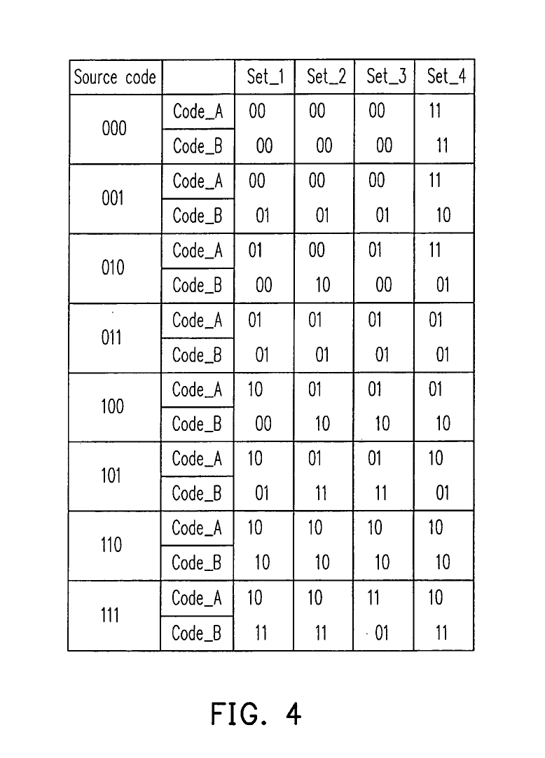

Referring to FIG. 4, FIG. 4 is a diagram showing a 3-bit binary code encoding table according to the first embodiment of the present invention. As shown in FIG. 4, a 3-bit binary code Code_Data can be divided into two 2-bit first codes Code_A and Code_B. Please note, in this embodiment, the 3-bit binary code Code_Data is a summation of the two 2-bit first codes Code_A and Code_B. The first codes are also binary codes and summed up by shifting a most significant bit (MSB) of the second first code Code_B to a position of a least significant bit (LSB) of the first first code Code_A, and then adding the two first codes Code_A and Code_B together. It is noted that there are more than one way to encode any 3-bit binary code Code_Data. As shown in FIG. 4, there are four different encoding strategies Set_1, Set_2, Set_3, and Set_4 for encoding the 3-bit binary code Code_Data.

As shown in FIG. 4, in the encoding strategies Set_1, Set_2 and Set_3, an MSB of the second first code Code_B is shifted to a position of an LSB of the first first code Code_A, and then adding the code Code_A and the shifted code Code_B together, so as to obtain the 3-bit binary code Code_Data.

However, the foregoing encoding strategies are not limitations of the present invention. As can be seen in FIG. 4, the encoding strategy Set_4 is different from the encoding strategies Set_1-Set_3. The codes Code_A and Code_B and the code Code_Data do not have direct arithmetic relationship among them. Instead, they are encoded by directly looking up a look-up table.

Taking 3-bit binary codes 101 as an example, as shown in FIG. 4, each encoding strategy Set_1-Set_4 corresponds to a distinct result. For example, according to the encoding strategy Set_1, the Code_Data (101) is encoded into Code_A and Code_B, which are 10 and 01 respectively.

$$\begin{matrix}101 \to & 10 \\ & \underline{+ 01} \\ & 101\end{matrix}$$

Furthermore, according to the encoding strategies Set_2 and Set_3, the Code_Data (101) is encoded into Code_A and Code_B, which are 01 and 11 respectively.

$$\begin{matrix}101 \to & 01 \\ & \underline{+ 11} \\ & 101\end{matrix}$$

Moreover, according to the encoding strategy Set_4, the Code_Data (101) is encoded into Code_A and Code_B, which are 01 and 11 respectively. Please note that, as described above, the encoding strategy is referred to a look-up table, and there is no arithmetic relationship among Code_A, Code_B, and Code-Data.

It should be noted that, in each of the above-mentioned encoding strategies Set_1-Set_4, the present invention can find some codes to embed the clock information of a clock signal without influencing coding values of the aforementioned codes representing the original data. For example, as shown in FIG. 4, any of the 3-bit binary codes Code_Data corresponding to the first encoding strategy Set_1 can be divided into the first codes Code_A and Code_B. The code Code_A is selected from three values, 00, 01, and 10. The code Code_B is selected from four values, 00, 01, 10, and 11. Therefore, it is impossible to find a sequence of 00 to 11 in the above-mentioned encoding strategies Set_1-Set_4. Therefore, the present invention can utilize this specific sequence (00 to 11) to represent the clock information. In other words, the present invention can embed the codes (00 to 11) into the transmission line pair and transmits the embedded codes together with the other encoded data. In this way, when a receiving terminal receives the specific codes, the receiving terminal is able to know that the specific codes represent the clock information, and then extract the clock information from the entire data stream.

Please note that the foregoing encoder for implementing the above-mentioned encoding strategies can be implemented with a look-up table or a simple logic circuit (e.g., an arithmetic calculation circuit). The look-up table can be stored in a non-volatile memory, such as a read-only memory (ROM), a flash memory, and an electronically erasable programmable read-only memory (EEPROM). Furthermore, it should also be noted that the present invention exemplarily suggests encoding 3-bit image data into two 2-bit binary codes for transmission purposes; however, the bit number of the data to be encoded and the bit number of the codes do not in any way impose limitations to the present invention. In other words, the present invention can be utilized to encode image data having a larger bit number, or to encode image data into more codes having lower bit number. These variations all comply with the spirit of the present invention.

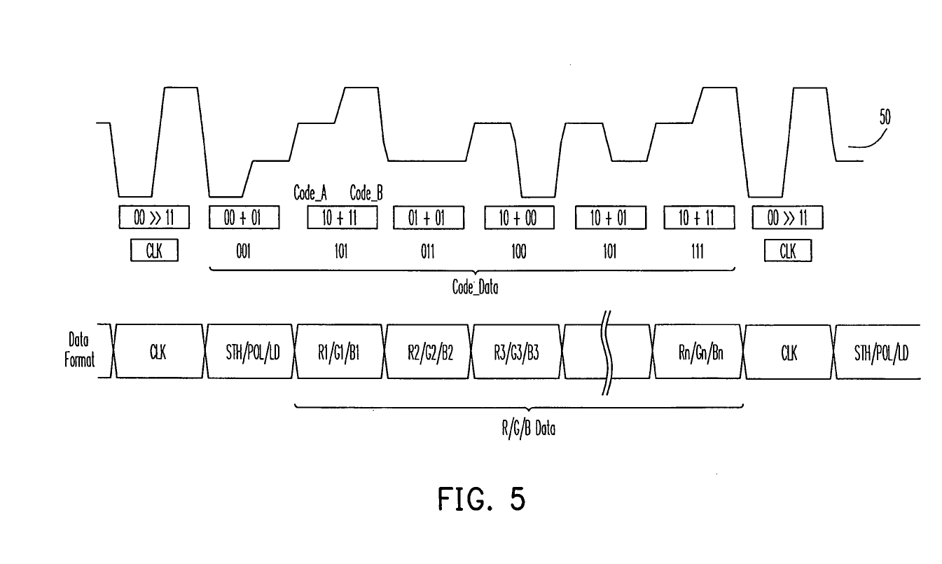

Referring to FIG. 5, FIG. 5 is a diagram showing a waveform of a transmission signal according to the first embodiment of the present invention. In this embodiment, each of four voltage levels is employed for respectively representing a specific 2-bit binary code, in which 00 represents the lowest level, 01 represents a lower level, 10 represents a higher level, and 11 represents the highest level. Image data R/G/B Data and the clock signal CLK are transmitted to an intra-panel driving chip via only one transmission line pair 50. As such, each driving chip is correspondingly inputted via only one transmission line pair 50. Therefore, the load thereof is convenient to control.

As shown in FIGS. 4 and 5, a 3-bit binary code Code_Data can be encoded into two first codes Code_A and Code_B, and the two first codes are transmitted between two clock signals CLK. As shown in FIG. 4, according to Set_1, there is no sequence from 00 to 11. Therefore, this data format (00 to 11) can be utilized as clock information of the clock signal CLK. Other data formats, which can be utilized to represent the image data according to the above-mentioned encoding strategies, are arranged and transmitted according to actual image data of the system. Taking FIG. 5 as an example, 3-bit binary codes Code_Data 001, 101, 011, 100, 101, and 111, representing the image data, are transmitted via data formats (00+01), (10+11), (01+01), (10+00), (10+01) and (10+11), respectively.

N-bit image data R/G/B Data can be composed of N-bit red image data R1, R2, . . . RN, green image data G1, G2, . . . GN, and blue image data B B2, . . . BN. As such, each bit of the red image data, green image data, and blue image data can be combined as the above-mentioned 3-bit binary data Code_Data, and then encoded into two 2-bit binary codes Code_A and Code B. As shown in FIG. 5, the first bit R1 of the red image data, the first bit G1 of the green image data, and the first bit B1 of the blue image data form a 3-bit binary code Code_Data. The 3-bit binary code Code_Data is then encoded by an encoder. The rest of the image data, R2 through RN, G2 through GN, and B2 through BN, are similarly encoded. In other words, the foregoing 3-bit data 001, 101, 011, 100, 101, and 111 represent the image data R/G/B Data, in which the red image data R_Data is 010111, the green image data G_Data is 001001, and the blue image data B_Date is 111011.

Further referring to FIGS. 4 and 5, taking R1/G1/B1 as an example, 101 is a value of the 3-bit binary code Code_Data. According to the first encoding strategy Set_1, the 3-bit binary code Code_Data is divided into two first codes Code_A and Code_B, where the first code Code_A is 10, and the first code Code_B is 11. The rest of the 3-bit binary codes are similarly encoded into two first codes Code_A and Code_B according to the same encoding strategy. In this way, the receiving terminal is capable of recovering the original image data (the original 3-bit binary data) through decoding the first codes Code_A and Code B, and then drives the display device according to the image data. In this embodiment, the image data are encoded according to the first encoding strategy Set_1, but the present invention may select another encoding strategy and such selection does not exceed the scope of the present invention.

It can be concluded from the foregoing teachings that as long as the bit number of the image data R/G/B Data is known, the number of clock signals having different phases needed for encoding a pixel can be determined accordingly. For example, a 10-bit image data R/G/B Data requires a (3×10/3)×2+2+2=24 clock signals CLK having different phases to transmit. In the above-mentioned equation, please note, besides the pixel data (which require (3×10/3)×2=20 clock signals) itself, a 3-bit control signal STH/POL/LD, which requires two additional clock signals, is also required in the data transmission procedure. In addition, the clock information of the clock signal CLK is represented by the combination of 00 and 11 (as mentioned earlier, the clock information is 00 to 11), which requires two clock signals to transmit. As such, it can be inferred that a 10-bit image data R/G/B Data under the same clock signal frequency has a bit rate which is 1.375 (33/24) times of the bit rate of the conventional transmission interface.

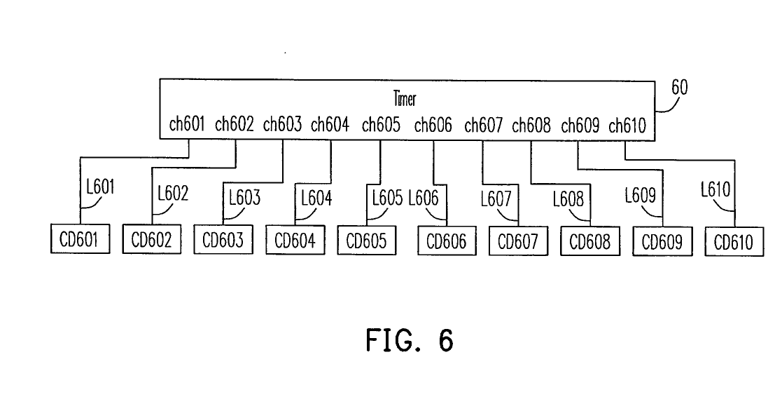

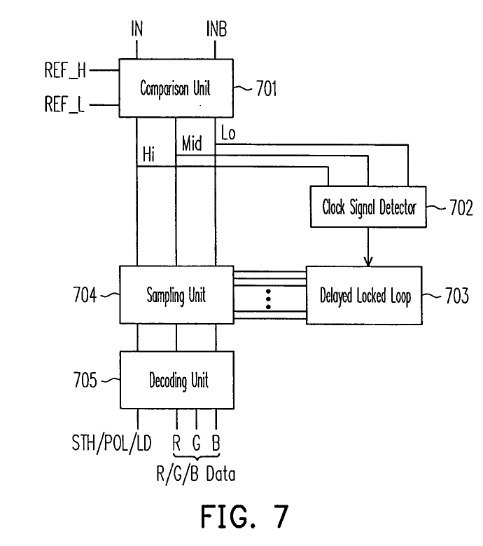

FIG. 6 depicts the first embodiment applied in a display panel environment. The display panel environment includes a timer 60, a plurality of channels Ch601, Ch602, . . . Ch610, a plurality of transmission line pairs L601, L602, . . . L610, and a plurality of column drivers CD601 CD602, . . . CD610. The timer 60 controls the output of each of the channels Ch601-Ch610, and transmits the image data via the transmission line pairs L601-L610 to the column drivers CD601-CD610. It can be clearly observed from FIG. 6 that the display panel includes 10 column drivers CD601-CD610, and each of the column drivers CD601-CD610 respectively requires only one transmission line pair L601-L610. Therefore, the entire display panel requires only 10 transmission line pairs L601-L610 without additional control lines to transmit the control signal STH/POL/LD. Furthermore, the loads of the transmission line pairs L601-L610 are easily estimated, and signals transmitted through the transmission line pairs L601-L610 are not influenced by each other. In this manner, the display panel can well support high-frequency applications.

FIG. 7 is a functional block diagram of a data receiving apparatus according to the first embodiment of the present invention. The data receiving apparatus includes a comparison unit 701, a clock signal detector 702, a delayed locked loop 703, a sampling unit 704, and a decoding unit 705. The comparison unit 701 is coupled to the sampling unit 704 and the clock signal detector 702. The clock signal detector 702 is coupled to the delayed locked loop 703. The delayed locked loop 703 is coupled to the sampling unit 704. The sampling unit 704 is coupled to the decoding unit 705. The comparison unit 701 receives an encoded signal pair, IN and INB, in which INB is a bar value of IN. The comparison unit 701 also receives a high level reference voltage REF_H, and a low level reference voltage REF_L. The comparison unit 701 compares the signal input pair IN and INB with the two reference voltages REF_H and REF_L, and obtains three level indication signals Hi, Mid and Lo. The three level indication signals Hi, Mid and Lo are inputted into both the clock signal detector 702 and the sampling unit 704. The clock signal detector 702 extracts the clock information of the clock signals CLK from the inputted level indication signals Hi, Mid and Lo. Then, the clock signal detector 702 transmits the extracted clock information of the clock signals CLK to the delayed locked loop 703. The delayed locked loop 703 generates a plurality of clock signals CLK having different phases according to the clock information for providing clock signals having needed phases to the sampling unit 704. Furthermore, the delayed locked loop 703 appropriately controls the delays of each of the clock signals having different phases, so as to prevent clock skew. In such a way, the sampling unit 704 will not extract incorrect image data RIG/B Data. With these clock signals having different phases, the sampling unit 704 can correctly sample desired level indication signals Hi, Mid and Lo. The decoding unit 705 then decodes corresponding image data RIG/B Data and control signals STH/POL/LD according to the correct level indication signals Hi, Mid and Lo.

However, it should be noted that the delayed locked loop 703 is regarded as an example and is not intended to be a limitation of the present invention. In the actual implementation, the present invention may also alternatively adopt a phase locked loop (PLL) instead of the delayed locked loop. For example, the PLL is adapted to generate a clock signal according to a data of a clock signal, and the sampling unit can then utilize the clock signal to sample the level indication signal so as to obtain a corresponding image data. This variation still remains within the scope of the present invention.

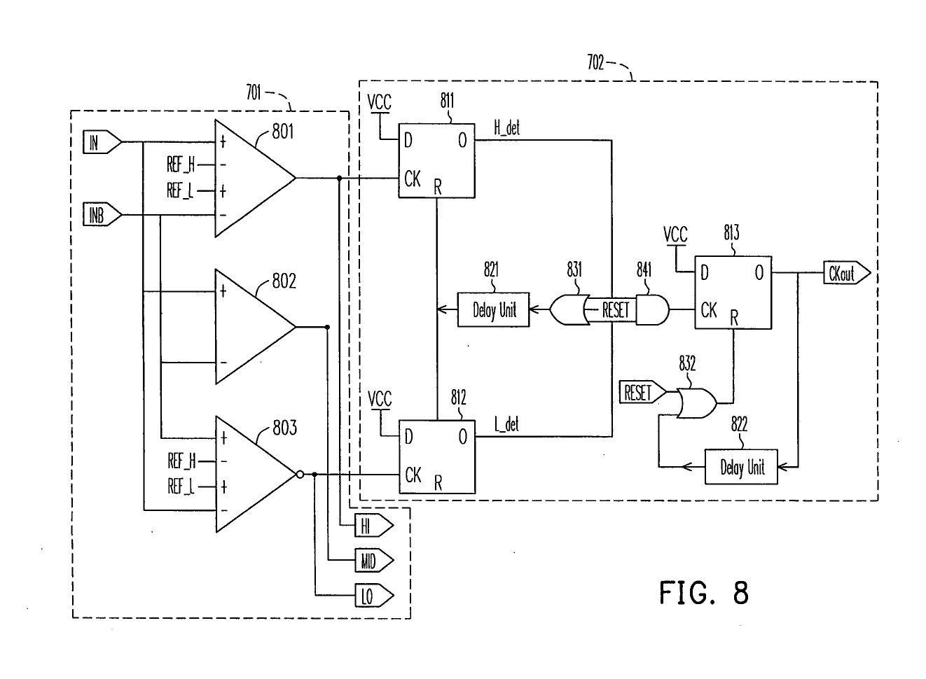

FIG. 8 shows circuits of a comparison unit 701 and a clock signal detector 702 of the data receiving apparatus shown in FIG. 7. The extracted data of the clock signals CLK is to be transmitted to the delayed locked loop 703 so as to generate a plurality of clock signals having different phases for extracting the image data R/G/B Data. As such, the quality of the signals is very important. Therefore, according to an aspect of the embodiment, a differential input circuit is employed in the circuit structure for improving noise immunity thereof. As shown in FIG. 8, the circuit diagram illustrates a circuit including three comparators 801, 802 and 803, three D flip-flops 811, 812 and 813, two delay unit 821 and 822, two OR gates 831 and 832, and an AND gate 841. The first comparator 801 receives encoded signal pair IN and INB, and two reference voltage REF_H and REF_L. An output terminal of the first comparator 801 is coupled to the first D flip-flop 811. The third comparator 803 is a inverted-type comparator including an input terminal receiving the encoded signal pair IN and INB and two reference voltages REF_H and REF_L, and an output terminal coupled to the second D flip-flop 812. The second comparator 802 receives the encoded signal pair IN and INB. The first D flip-flop 811 receives a supplying voltage VCC, and includes a reset terminal R coupled to an output terminal of the first delay unit 821, and an output terminal coupled to the first OR gate 831 and the AND gate 841. The second D flip-flop 812 receives the supplying voltage VCC, and includes a reset terminal R coupled to the output terminal of the first delay unit 821, and an output terminal coupled to the first OR gate 831 and the AND gate 841. The first OR gate 831 receives a reset signal RESET, and includes an output terminal coupled to an input terminal of the first delay unit 821. The AND gate 841 includes an output terminal coupled to the third D flip-flop 813. The third D flip-flop 813 receives the supplying voltage VCC, and includes a reset terminal R coupled to an output terminal of the second OR gate 832, and an output terminal coupled to the second delay unit 822 and outputting a clock indication signal CKout. The second delay unit 822 includes an output terminal coupled to the second OR gate 832. The second OR gate 832 receives the reset signal RESET.

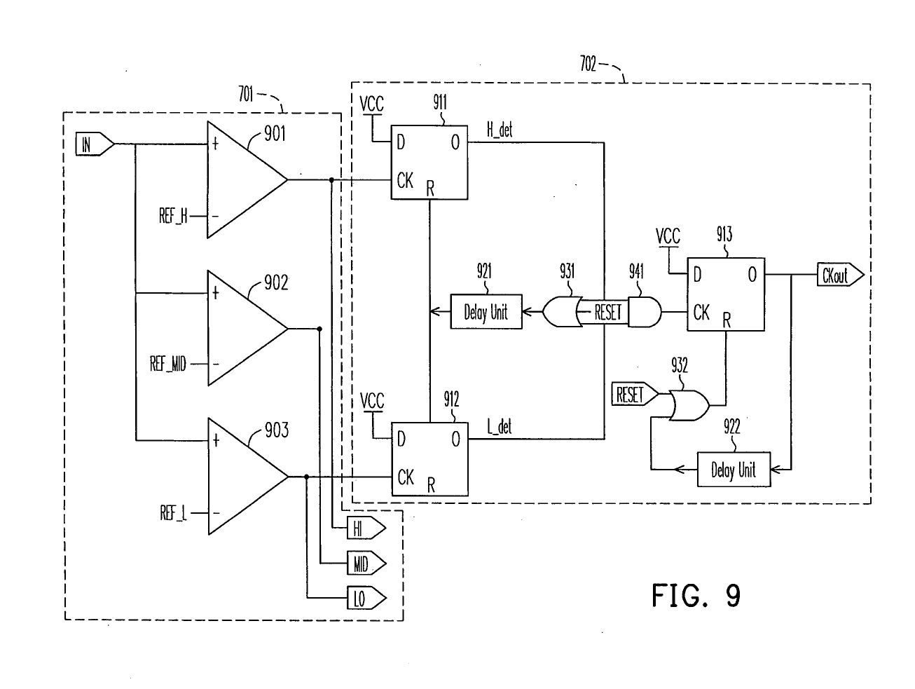

FIG. 9 is a diagram showing circuits of a comparison unit 701 and a clock signal detector 702 of another data receiving apparatus shown in FIG. 7. This is different from the foregoing structure shown in FIG. 8 in that the foregoing structure shown in FIG. 8 adopts differential input while the structure shown in FIG. 9 does not, so that this structure does not need to receive encoded signal input pair IN and INB, and only needs to receive the encoded signal IN. However, the comparison unit 701 according to this structure requires three reference voltages REF_H, REF_L and REF_MID. The reference voltage REF_MID is a medium level reference voltage. As shown in FIG. 9, the circuit includes three comparators 901, 902 and 903, three D flip-flops 911, 912 and 913, two delay units 921 and 922, two OR gates 931 and 932, and an AND gate 941. The first comparator 901 receives the encoded signal IN and the reference voltage REF_H, and includes an output terminal coupled to the first D flip-flop 911. The third comparator 903 includes an input terminal receiving the encoded signal IN and a reference voltage REF_L, and an output terminal coupled to the second D flip-flop 912. The second comparator 902 receives the encoded signal IN and a reference voltage REF_MID. The first D flip-flop 911 receives a supplying voltage VCC, and includes a reset terminal R coupled to an output terminal of the first delay unit 921, and an output terminal coupled to the first OR gate 931 and the AND gate 941. The second D flip-flop 912 receives the supplying voltage VCC, and includes a reset terminal R coupled to the output terminal of the first delay unit 921, and an output terminal coupled to the first OR gate 931 and the AND gate 941. The first OR gate 931 also receives a reset signal RESET, and includes an output terminal coupled to an input terminal of the first delay unit 921. The AND gate 941 includes an output terminal coupled to the third D flip-flop 913. The third D flip-flop 913 receives the supplying voltage VCC, and includes a reset terminal R coupled to an output terminal of the second OR gate 932, and an output terminal coupled to the second delay unit 922 and outputting a clock indication signal CKout. The second delay unit 922 includes an output terminal coupled to the second OR gate 932. The second OR gate 932 further receives a reset signal RESET. Further, it should be noted that although the comparison unit 701 and clock signal detector 702 are illustrated according to the above-mentioned embodiments, the comparison unit 701 and the clock signal detector 702 are not necessarily restricted to the same coupling relationships as taught above.

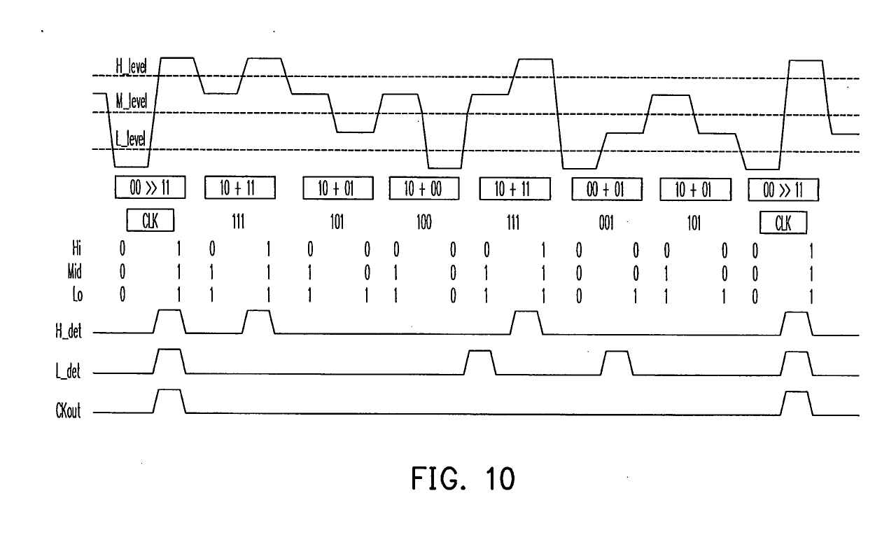

FIG. 10 is a diagram showing another waveform of a transmission signal according to the first embodiment of the present invention. The 3-bit binary codes Code_Data in sequence are 111, 101, 100, 111, 001 and 101.

Now FIG. 7, 8 (or 9) together with FIG. 10 are reverted to for an explanation about the principle of operation of the extraction circuit (data receiving circuit). Firstly, the comparators 801-803 (or 901-903) compare the inputted signals with the reference voltages, and output three level indication signals Hi, Mid, Lo. The level indication signals are outputted as follows: when the inputted encoded signal IN is 00, the three level indication signals Hi, Mid, Lo are sequentially 0, 0, 0; when the inputted encoded signal IN is 01, the three level indication signals Hi, Mid, Lo are sequentially 0, 0, 1; when the inputted encoded signal IN is 10, the three level indication signals Hi, Mid, Lo are sequentially 0, 1, 1; and when the inputted encoded signal IN is 11, the three level indication signals Hi, Mid, Lo are sequentially 1, 1, 1. When the high level indication signal Hi changes from 0 to 1, the high level detection signal H_det changes from 0 to 1. Likewise, when the low level indication signal Lo changes from 0 to 1, the low level detection signal L_det changes from 0 to 1. In order to avoid that the high level detection signal H_det and the low level detection signal L_det are accumulated to a period of a next sampling signal, after the high level detection signal H_det changes from 0 to 1 or the low level detection signal L_det changes from 0 to 1, the first delay unit 821 (or 921) delays a time shorter than a bit period, so as to reset the data stored in the D flip-flops 811 (911) and 812 (912). When the inputted encoded signal IN changes from 00 to 11, the three level indication signals Hi, Mid, Lo change from 0, 0, 0 to 1, 1, 1. In the meantime, both the high level detection signal H_det and the low level detection signal L_det change from 0 to 1. Then a signal having the logic level 1 is generated from the AND gate 841 (or 941), and then inputted to the D flip-flop 813 (or 913). Afterwards, the third D flip-flop 813 (or 913) outputs a clock indication signal CKout according to the signal outputted from the AND gate 841 (or 941). Therefore, the clock indication signal CKout is 1 at that time, and the delayed locked loop 703 is coupled thereafter to generate clock signals having different phases and provide them to the sampling unit 704 for subsequent operations. In order to avoid the clock indication signal CKout to be accumulated to a period of a next sampling signal, after the clock indication signal changes from 0 to 1, the second delay unit 822 (or 922) delays a time shorter than a bit period, so as to reset the data stored in the D flip-flop 813 (913).

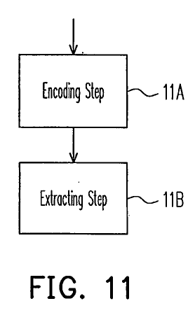

According to the first embodiment of the present invention, a method of transmitting a multi-level voltage signal including a clock signal and a data signal is proposed. As shown in FIG. 11, the transmission method includes an encoding step 11A and an extracting step 11B. In the encoding step 11A, a 3-bit binary code is divided into two 2-bit first codes. In the extracting step 11B, information of the clock signal is detected from a specific format in the two 2-bit first codes.

In summary, the high transmission rate interface transferring both the clock signal and the data signal according to the present invention uses a specific encoding strategy to divide a binary code into two first codes, so as to allow a single transmission line pair to simultaneously transfer a clock signal along with data. This can lower the load, save the power consumption, and avoid interference between different signals and clock skew. The interface and the method rely on multi-level technology to increase a bit rate thereof, so that not only the disadvantages of conventional multiple transmission line pairs are avoided, but the transmission efficiency also gets higher than the conventional point-to-point transmission technology.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A high transmission rate interface for transmitting both a clock and data, adapted for an intra-panel liquid crystal display (LCD), the high transmission rate interface comprising:
a clock detection circuit adapted for receiving a data stream and detecting a specific data format in the data stream so as to extract clock information from the data stream; and
a data extraction circuit, coupled to the clock detection circuit and adapted for sampling the data stream according to the clock information and extracting an image data according to a sampling result.

2. The high transmission rate interface according to claim 1, wherein the data stream is carried by a multi-level voltage signal, the multi-level voltage signal comprises a plurality of voltage levels, and each of the voltage levels represents an m-bit binary code.

3. The high transmission rate interface according to claim 2, wherein the specific data format is expressed by two consecutive m-bit binary codes.

4. The high transmission rate interface according to claim 2 further comprising:
a comparison circuit, adapted for receiving the multi-level voltage signal, and comparing the multi-level voltage signal with a reference signal to generate the data stream.

5. The high transmission rate interface according to claim 4, wherein the data extraction circuit comprises:
a delayed locked loop, coupled to the clock detection circuit, for generating a plurality of clock signals having different phases according to the clock information;
a sampling unit, coupled to the comparison unit and the delayed locked loop, for sampling the data stream according to the clock signals having different phases to derive the sampling result; and
a decoding unit, coupled to the sampling unit, for receiving the sampling result and decoding the sampling result to obtain the image data.

6. The high transmission rate interface according to claim 5, wherein the decoding unit is a look-up table or a calculator.

7. The high transmission rate interface according to claim 6, wherein the look-up table is stored in a memory.

8. The high transmission rate interface according to claim 7, wherein the memory is a non-volatile memory.

9. The high transmission rate interface according to claim 2, wherein m=2, and the specific data format is expressed by consecutive 00 and 11.

10. The high transmission rate interface according to claim 1, wherein the specific data format only corresponds to the clock information and does not correspond to any image data.

11. A high transmission rate interface for transmitting both a clock and data, adapted for a liquid crystal display (LCD), the high transmission rate interface comprising:
an encoder, for embedding clock information with a specific data format into a data stream; and
a clock detection circuit adapted for receiving the data stream and detecting the specific data format, so as to extract the clock information from the data stream.

12. The high transmission rate interface according to claim 11, wherein the encoder further encodes image data, so as to form the data stream.

13. The high transmission rate interface according to claim 12, the high transmission rate interface further comprising:
a data extraction circuit, coupled to the clock detection circuit and adapted for sampling the data stream according to the clock information and extracting the image data according to a sampling result.

14. The high transmission rate interface according to claim 12, wherein the encoder encodes n-bit image data, so as to generate a plurality of m-bit binary codes, which form the data stream.

15. The high transmission rate interface according to claim 14, wherein the data stream is carried by a multi-level voltage signal, wherein the multi-level voltage signal comprises a plurality of voltage levels, each of the voltage levels represents an m-bit binary code.

16. The high transmission rate interface according to claim 15 further comprising:
a comparison circuit, adapted for receiving the multi-level voltage signal and comparing the multi-level voltage signal with a reference signal to generate the data stream.

17. The high transmission rate interface according to claim 13, wherein the data extraction circuit comprises:
a delayed locked loop, coupled to the clock detection circuit for generating a plurality of clock signals having different phases according to the clock information;
a sampling unit, coupled to the comparison unit and the delayed locked loop, for sampling the data current according to the clock signals having different phases to derive the sampling result; and
a decoding unit, coupled to the sampling unit, for receiving the sampling result and decoding the sampling result to obtain the image data.

18. The high transmission rate interface according to claim 17, wherein the decoding unit is a look-up table or a calculator.

19. The high transmission rate interface according to claim 18, wherein the look-up table is stored in a memory.

20. The high transmission rate interface according to claim 19, wherein the memory is a non-volatile memory.

21. The high transmission rate interface according to claim 17, wherein the decoding unit recovers the sampling result to n-bit image data for decoding operation.

22. The high transmission rate interface according to claim 11, wherein the specific data format is configured by two consecutive m-bit binary codes.

23. The high transmission rate interface according to claim 22, wherein m=2, and the specific data format is expressed by consecutive 00 and 11.

24. The high transmission rate interface according to claim 11, wherein the specific data format only corresponds to the clock data and does not correspond to any image data.
